(19) United States
(12) Patent Application Publication
(10) Pub. No.: US 2007/0055593 A1
(43) Pub. Date: Mar. 8, 2007

(54) Systems and methods for implementing directed trust services

(76) Inventors: Owen L. Perrin, Edison, NJ (US); James L. Hendrickson, Rowayton, CT (US); Otto Arias, Red Bank, NJ (US); Steven J. Olsen, Staten Island, NY (US)

Correspondence Address: PILLSBURY WINTHROP SHAW PITTMAN LLP, P.O. BOX 10500, MCLEAN, VA, 22102, US

(21) Appl. No.: 11/218,600

(22) Filed: Sep. 6, 2005

(51) Int. Cl. G06Q 40/00

(52) U.S. Cl. 705/35

(57) ABSTRACT

A trust accounting system and securities broker platform are closely integrated such that a third-party investment manager is notified of an amount of principal cash that is available for investment. Investments made are reported to the trust accounting system. Information flow between the third-party investment manager and the trust accounting system occurs daily. Consequently, the operator of the trust accounting system, e.g., a bank, can perform its fiduciary oversight duty while maximizing return on investment of principal cash, and beneficiaries can obtain up-to-date information about the state of trust investments and income.

### BACKGROUND

1. Field of the Invention

The present invention relates generally to financial services. More particularly, the present invention relates to systems and methods that permit a trustee, which does not traditionally provide securities broker/dealer services, and a securities broker/dealer, which traditionally does not have the infrastructure or capability to provide trustee services, to leverage each other's services and capabilities for the benefit of a common client.

2. Background of the Invention

Trusts are an essential tool in financial planning. They are typically designed to preserve wealth, provide for individuals and families, control the distribution of one's assets and accomplish a wide range of specific goals. Trusts are also often established to, among other things, minimize estate taxes, and provide a legacy for favored charities—with tax benefits for one's self and one's heirs. Trusts are also often established to provide for one's retirement and to manage one's affairs in the event of incapacitation. One of the most common purposes of trusts, of course, is to avoid the costs, delays and publicity of probate—the process by which a court oversees the execution of a decedent's will.

A fundamental principle of a trust is that the trustor, grantor, or creator of the trust relinquishes control over the assets placed in trust. Once created, a designated trustee is thereafter responsible for managing and overseeing activity with respect to the assets, or corpus, of the trust. While the trustee of a trust is often an individual, it is increasingly more common, especially when the corpus of a given trust is relatively large, for trustors to rely on financial institutions, such as banks, to serve as trustees. Indeed, a bank is uniquely qualified to serve as a trustee since it typically already has in place established administrative systems and procedures for tracking assets and updating and reconciling account information.

While some trusts severely restrict or even forbid using trust assets for investment purposes, many trusts allow for a certain degree of asset investment, as long as such asset investment falls within predetermined guidelines or rules. However, while banks and other financial institutions are well-equipped to serve as trustees from an accounting and fiduciary perspective, personnel at a typical bank might not have the expertise (or desire) to take on the responsibility of investing trust assets on behalf of a beneficiary of the trust.

On the other hand, traditional money managers, such as those associated with securities broker/dealers, are very well-equipped to recommend and execute specific investments. However, broker/dealer supporting software and other tools, are not typically designed with trustee services in mind. Moreover, broker/dealers may be expected to take a more aggressive (and thus perhaps more risky) position with respect to investing assets, while trustees may be expected to act more conservatively to avoid unnecessary risk in an effort to protect the corpus of a trust. Thus, for both legal and historical reasons, the services offered by a typical trustee and the services offered by a typical securities broker/dealer rarely overlap.

### BRIEF SUMMARY OF THE INVENTION

Various embodiments of the present invention provide unique implementations for providing directed trust services. In accordance with at least one embodiment, a communications link or data interface may be established between a trust accounting system operated by a trustee, such as a bank, and a third-party securities broker platform. The trustee opens an account on the securities broker platform in the name of the trustee, for the benefit of a predetermined client. Access to the account is thereafter provided to a money manager, such as a registered investment advisor, who is designated to provide investment services on behalf of the client. Using the communications link, the securities broker platform is updated with information sufficient to notify the money manager of an amount of trust assets that are available for investment. Typically, this amount reflects some portion of principal cash, which is exclusive of trust income.

As investments are made through the broker platform, the trust accounting system itself may be updated via the communications link. In this way, the trustee may have immediate and up-to-date information regarding asset investment and may, as a result, perform its oversight obligations in connection with its fiduciary duties as trustee.

While the present invention has applicability to any form of directed trust in which a trustee seeks and/or permits third-party investment management, the present invention is particularly applicable for implementing Delaware Direction Trusts (described herein), which expressly permit third-party investment management.

These and other features of the present invention, along with their attendant advantages, will be more fully appreciated upon a reading of the following detailed description along with the accompanying drawings.

### BRIEF DESCRIPTION OF THE DRAWINGS

FIG. 1 illustrates the relationships and connectivity between various parties and technology platforms that are employed in accordance with the present invention.

FIGS. 2-7 depict several models in accordance with which the present invention may be implemented.

### DETAILED DESCRIPTION OF THE INVENTION EMBODIMENTS

Recently, there has been a growing area of overlap between trustee services and investment or money manager services. Relevant trust laws in the state of Delaware, for example, provide for a more liberal approach to a trustee's traditional oversight of a trust. Specifically, in accordance with laws pertaining to a so-called “Direction Trust,” Delaware permits a trustee to relinquish some of its overall responsibility for overseeing the corpus of a trust by permitting a third party, such as an investment advisor, to control investments. Often times, such an advisor is a Registered Investment Advisor (RIA). When such an RIA is named in a trust for this purpose, the trustee is permitted to take investment direction from the RIA (or hand over investment responsibility) without the risk of liability. In practice, in creating a Delaware Direction Trust, the creator of the trust delegates investment responsibility to a party other than the trustee and absolves the trustee of investment responsibility. The creator of the trust may also give a party, other than the trustee, authority to hire and fire investment managers.

It is noted that the Delaware Direction Trust is a “legalized” form of the so-called general “directed trust.” In a directed trust, there is no express language appointing a third party investment manager other than the trustee. In such a trust, the trustee may exercise its discretion and delegate investment responsibility to a third party manager. However, the trustee will continue to be liable to the trust beneficiaries for investment performance. In some jurisdictions, the manager may also be directly liable to the beneficiaries. The trustee may also have a claim for reimbursement against the manager on a contract basis.

In any event, directed trusts (and especially the Delaware Direction Trust) are becoming increasingly popular since at least a portion of a trust's corpus can be professionally managed by a money manager of the trustor's choosing, and one that is independent of what might be viewed as a more conservative bank trustee.

Despite the availability of directed trusts, including the Delaware Direction Trust, there nevertheless remains significant deficiencies in, among other things, the manner in which a bank trustee and an RIA or other money manager communicate with one another. In particular, there remain deficiencies in how finds are made available to an RIA or other money manager by a bank trustee for purposes of investment, in how assets are monitored and tracked, and in how adequate reporting of trust affairs in connection with asset investment is performed.

Thus, in accordance with at least one embodiment of the invention, information flow across a communications link between a securities broker platform and a trust accounting system occurs periodically, e.g., daily, or even more frequently. Clients (e.g., trust creators or grantors, and beneficiaries) may also gain access to trust asset information through a portal, such as an Internet web site, which is linked to the trust accounting system. That same portal may also provide access to other account information (e.g., checking account, savings account, CDs) that might be stored by the bank trustee on behalf of the client.

The systems and methods of the present invention also may support generating reports and other documents from the trust accounting system, including statements, confirms, tax reports, scheduled remittances, and discretionary payments.

In an effort to maintain appropriate control over assets made available to the securities broker platform, restrictions may be imposed on the ways in which cash can be removed from an investment account. For example, ACATS, checks, wire transfers and ACH transactions are preferably blocked or severely restricted, such that cash can not be easily transferred out of an account without the trustee bank's knowledge.

Unlike a conventional trust, a directed trust is structured such that each client (e.g., trustor, grantor, creator, trustee, etc.) can designate his or her own investment manager to manage at least a portion of trust corpus assets, while the trustee still maintains fiduciary oversight. The availability of directed trusts, and in particular, the Delaware Direction Trust, has spawned an entire “investment advisor market” in which money managers offer their services to manage trust assets. Embodiments of the present invention bridge the divide that exists between these money managers, such as RIAs, their brokerage tools (e.g., order and clearing software, such as that offered by Pershing, Jersey City, N.J.) (hereafter “broker platforms”), and an established trustee, such as a bank (hereafter, “trustee,” “bank” or “financial institution”).

In accordance with at least one embodiment, directed trust products and services in accordance with principles of the present invention are implemented in the context of a custody/sub-custody relationship between the bank and the RIA, under which the bank, as trustee, may maintain fiduciary oversight. This relationship, between the bank and the RIA (or other money manager), may enable the inventive products and services provided by the present invention embodiments to provide a full range of in-depth trust administrative services to RIAs, Introducing Broker Dealers (IBDs) and their end clients who use broker platforms.

In the systems and methods for implementing directed trust services in accordance with the present invention, the trustee administers trusts in accordance with their terms and conditions, as well as exercises discretionary powers granted under the trust instrument. Additionally, the trustee prepares and files required federal and state fiduciary tax returns, manages real estate and special assets, and assists in development of investment objective consistent with the trust objective and needs of the beneficiaries and in compliance with the Prudent Investor Act.

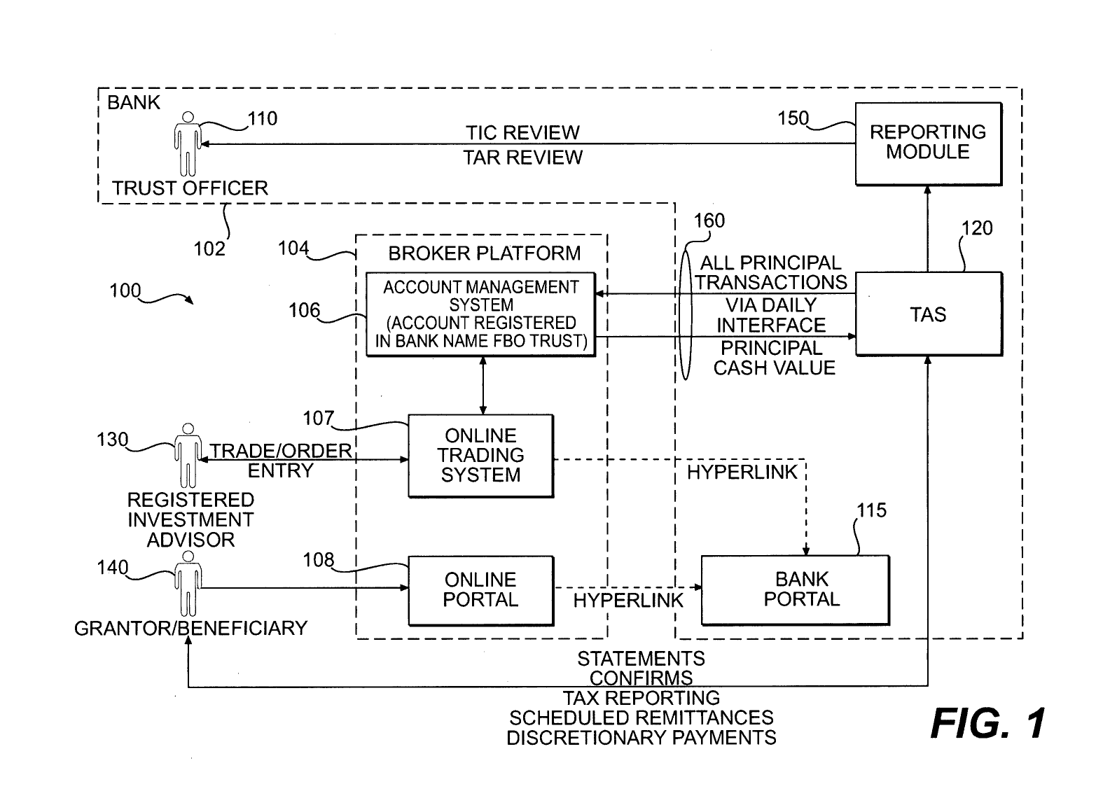

FIG. 1 illustrates exemplary relationships and connectivity between the various parties and technology platforms 100 that are employed to implement the directed trust systems and services in accordance with at least one embodiment of the invention. Those skilled in the art will appreciate that the several systems, technology platforms, and facilities, described herein and depicted in the drawings are implemented on computer systems, including main frame and desktop computers, that may be arranged in a network using well-known communication protocols. As shown in FIG. 1, the facilities of a bank 102 and a broker platform 104 are at the heart of the systems and methodology of embodiments of the invention. Bank 102, as a traditional provider of trustee services, includes a Trust Account System (TAS) 120 that keeps track of a plurality of individual trust accounts. TAS 120 comprises the functionality to generate, e.g., statements, confirms, tax reporting statements, scheduled remittances, and discretionary payments that are issued, ultimately, to a grantor/beneficiary 140 of a given trust. The functionality of TAS 120 is the very functionality that a typical money manager or RIA would not otherwise have access to conventionally.

More specifically, TAS 120 may be configured to be capable of keeping track of and reconciling the accounts associated with a trust. Generally speaking, trust assets are separated into principal and income. Principal is the portion of the trust that was originally designated and, as such, cannot, under most trust agreements, be paid out under any circumstances. The income portion, or that portion of trust assets resulting from investment return (of, e.g., 5% or 6% per year in dividends, capital gains, etc.) on the principal, can be distributed to the beneficiaries of the trust, and the trustee is generally obligated to do so. TAS 120 performs the often times complex accounting calculations to ensure that these respective portions of trust assets are not inadvertently intermingled.

As explained previously, in the case of a directed trust, a portion of the designated principal is made available to an advisor, such as an RIA 130. Trust income, on the other hand, is typically not made available for investment. As will be more fully explained below, TAS 120 periodically (e.g., daily) notifies RIA 130 of the amount of principal funds that are available for investment. Conventionally, such close integration of a trustee's accounting system (e.g., TAS 120) and the services of an RIA has been unavailable.

In accordance with at least one embodiment of the invention, a third-party broker platform 104 is employed and accessed by RIA 130 to make trades or otherwise invest certain designated amounts of principal money or funds on behalf of the grantor/beneficiary 140. More particularly, RIA 130 might access an online trading system 107 (such as “NetXPro,” available from Pershing LLC, Jersey City, N.J.), which can effect the requested trades and investments entered by RIA 130. At the same time, grantor/beneficiary 140 can similarly access broker platform 104 through, for example, a separate online portal 108 (such as “NetXClient,” also available from Pershing LLC, Jersey City, N.J.).

Both online trading system 107 and online portal 108 of broker platform 104 may be linked to a bank portal 115 (such as “BNY Connect,” offered by Bank of New York, New York, N.Y.), which is preferably accessible over a public network, such as the Internet. Bank portal 115 preferably provides instant access to a client's investment and banking accounts in one secure place. Although not illustrated, bank portal 115 may be in communication with TAS 120 as well. In one implementation, bank portal 115 may also enable a client to monitor investment accounts online. Thus, a client may, for example, verify positions, see all positions as of the previous business day's close, and view holdings by asset class or industry sectors, or retrieve transaction history to review specific transactions for some period, for example, up to 15 months, including pending trades and tax lot data. Additionally, the client may organize account information to, for example, group accounts into multiple views to suit personal preferences, and grant “view only” access to advisors to grant online viewing access to, e.g., attorneys, accountants and other advisors of the client.

Bank portal 115 still further may provide access to a wide variety of financial news and market data that enables a client to be informed about current financial and business developments, get performance data on market indices, equities, options and mutual funds, analyst ratings, company profiles, stock quotes, and business news and create interactive charts to monitor and analyze investments. In sum, and in particular connection with the invention, bank portal 115 provides both RIA 130 and Grantor/Beneficiary 140 a comprehensive view of the status of a trust account.

Similarly, online trading system 107 may be in communication with a broker platform account management system 106 of broker platform 104. Broker platform account management system 106 is the system that conventionally would be accessible to online trading system 107 for the benefit of a traditional money manager, and keep track of positions in a given investment account, e.g., stocks, bonds, futures, mutual funds, treasuries, money market accounts, etc. In accordance with at least one embodiment of the invention, however, broker platform account management system 106 may be closely integrated with TAS 120, which is under the direct management and control of bank 102. In accordance with at least one embodiment of the present invention, an account on broker platform account management system 106, that is to be used by a money manager or RIA 130 in the context of a directed or Direction trust, is opened in, for example, the name of bank 102 FBO (for the benefit of) a given trust.

FIG. 1 further illustrates information flow across data interface 160 between TAS 120 and broker platform account management system 106 that occurs at least daily, and perhaps as close to real time as is practicable (e.g., twice daily, hourly, upon transaction completion). Data interface 160 is preferably implemented using well-known Electronic Data Interchange (EDI) techniques. However, those skilled in the art will appreciate that the precise technique and protocols used for implementing data interface 160 are not critical to the present invention.

Broker platform account management system 106 may be configured to send to TAS 120 data indicating all principal transactions (e.g., trades made by RIA 130) that have occurred, and TAS 120 feeds broker platform account management system 106 the principal cash value that is available for investment. In this way, TAS 120 is able to maintain close monitoring of an RIA's trading practices, and the RIA may be continually advised of the precise amount of assets that are available for investment.

A trust officer 110, who is employed by trustee bank 102, may monitor trust accounts on TAS 120 for Trust Investment Committee (TIC) and Trust Administrative Review (TAR) review via, e.g., an intermediate reporting module 150, such as Advent (available from Advent Software, San Francisco, Calif.), which may provide advanced portfolio accounting and performance reporting. The purpose of review is to oversee the RIA investment process to make sure the investments being made are prudent, yet designed to maximize the return on the principal made available for investment.

With the close integration of TAS 120 and broker platform account management system 106 in accordance with the invention, it is possible to significantly reduce the amount of cash that might otherwise have to be kept in reserve by a money manager/RIA 130 to ensure that sufficient cash is available to distribute as income to beneficiaries. That is, because TAS 120 is a system designed to closely and separately account for and monitor principal and income, money manager/RIA 130 need not be burdened with “covering for” any shortfall that might arise on the trustee side. This is of particular utility as it enables the money manager/RIA 130 to maximize the amount of principal that is available for investment. The described unique combination of systems and methodologies also preserve the trustee's oversight responsibilities while maximizing a money manager's access to investment principal, and at the same time, preclude the money manager from overdrawing the trust account.

The systems and methodologies described herein may also be viewed as a form of optimized trust compliance management. Bank 102, through TAS 120 and trust officer 110, ensures that a given trust's parameters or rules are being complied with. Without the close integration of TAS 120 and broker platform account management system 106 in accordance with the invention, trust officer 110 could not conduct his oversight and fiduciary duties on a timely basis.

Thus, in accordance with at least one embodiment of the invention, bank 102 may perform its fiduciary role using TAS 120 for trust accounting/reporting and make available the asset amount available for investment management to broker platform 104. This may be accomplished, as illustrated in FIG. 1, by implementing a data interface 160 between broker platform account management system 106 and TAS 120, allowing TAS 120 to mirror transaction history of the principal assets in custody with a given money manager or RIA 130 within the trustee's trust accounting system.

This close integration likewise permits the principal cash value to be provided to broker platform 104 for display via online trading system 107 which, in turn, allows an investment manager or RIA 130 to invest all principal assets, while bank 102, as trustee, maintains control of all cash.

In one implementation, directed trust accounts can be segregated into dedicated offices within Introducing Broker Dealer (IBD)/RIA regions on broker platform 104. This enables bank 102 restricted access to only the directed trust accounts on broker platform 104; perhaps more significantly, this enables strict controls over broker platform accounts for money movement (e.g., no Automated Customer Account Transfer Service (ACATS), check, Automated Clearing House (ACH) or wire disbursements) thereby enabling bank 102 to maintain adequate fiduciary control of the assets.

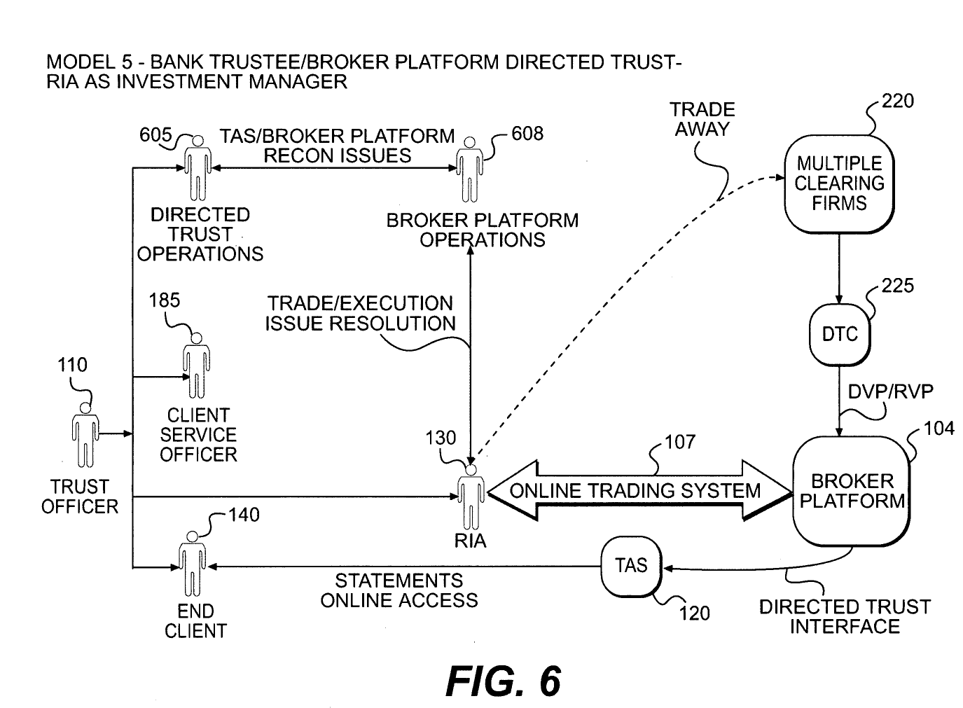

The close integration of broker platform account management system 106 and TAS 120 also enables bank 102 to develop detailed reconciliation reports for use within a Directed Trust Operations Group 605 (shown in, e.g., FIG. 6) within bank 102, that may provide even more effective oversight over directed trust operations.

For offering these enhanced services to clients, fees may be payable to bank 102 and may be assessed in various ways depending on the particular implementation.

For example, in one implementation, where the money manager does not a have strong prearranged relationship with bank 102, fees may be assessed in arrears based on the rest date of the trust, may be managed through a fee system for calculating trustee fees (also referred to herein as an Enhanced Fee System, or “EFS”), and may be captured within a general ledger (G/L) through standard processes.

In a second potential implementation, where bank 102, money manager/RIA 130, and broker platform 104 are closely aligned with one another, fees may be assessed quarterly in advance of the period, and may be managed through a client billing system controlled by broker platform 104. In such a case, fee debit may be captured within TAS 120.

In a further implementation, bank 102 may capture a Trustee Fee via a Net Cash Settlement Process. Fee Reconciliation Reports may provide sufficient detail for Directed Trust Operations within bank 102 to credit the appropriate G/L.

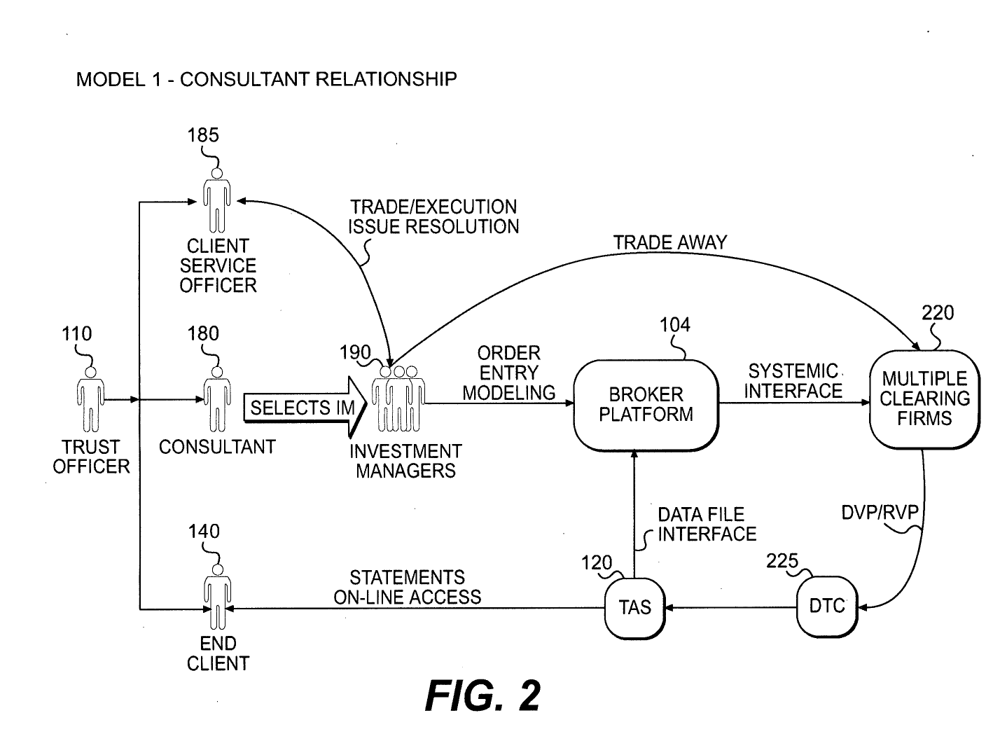

FIGS. 2-7 depict several models, viewed from a bank's perspective, that can be deployed in accordance with the present invention. Model 1, illustrated in FIG. 2, depicts a consultant relationship. Model 2 depicts a consultant relationship with separately managed account program. Model 3 depicts a family office relationship. Model 4 depicts a family office with separately managed account program. Model 5 depicts a bank/broker/dealer relationship with an RIA as investment manager. Model 6 depicts a bank/broker/dealer relationship with an RIA along with a separately managed account program. Models 1-4 depict cases where there is relatively less integration between a trustee and a broker platform, whereas Models 5 and 6 depict cases where there is substantially more integration.

Referring to FIG. 2 (Model 1), a trust officer 110 coordinates with a consultant 180 who selects one or more investment managers 190 who are then tasked with investing principal cash on behalf of end client or grantor/beneficiary 140. As explained previously, TAS 120 supplies to broker platform 104 an indication of the amount of principal cash that is available for investment. Investment managers 190 may enter trade orders into an account management system and the trades themselves may be effected via one or more clearing firms 220. Investment managers 190 may also effect trade away trades and thereby bypass broker platform 104. Investment managers 190 may coordinate with a client service officer 185 to resolve any trade or execution issues that might arise.

From a feedback perspective, clearing firms 220 may provide information to deposit trust company (DTC) 225 which is then loaded back into TAS 120. TAS 120, as explained previously, can then generate statements and supply information to online portals for the benefit of end client 140. More details regarding Model 1 and the other five models can be found in the tables below.

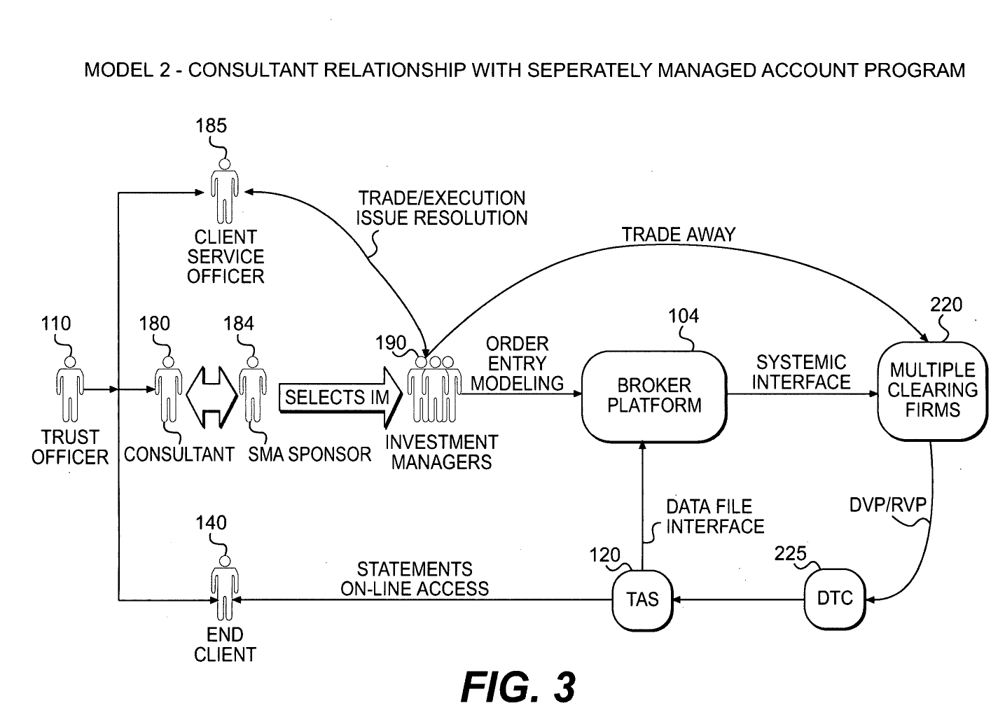

Model 2, illustrated in FIG. 3, is substantially the same as Model 1 but further includes a Separately Managed Account (SMA) sponsor 184 who is interposed between consultant 180 and investment managers 190. Thus, in accordance with Model 2, separately managed account sponsor 184 selects investment managers 190, in the first instance, rather than consultant 180. Unlike a traditional broker/registered investment advisor relationship, where a single investment professional might manage one or multiple segments of an asset allocation, an SMA Program provides an asset allocation which is comprised of multiple investment managers. Each manager specializes their investment strategy in their asset segment, hence providing greater opportunity for return on investment.

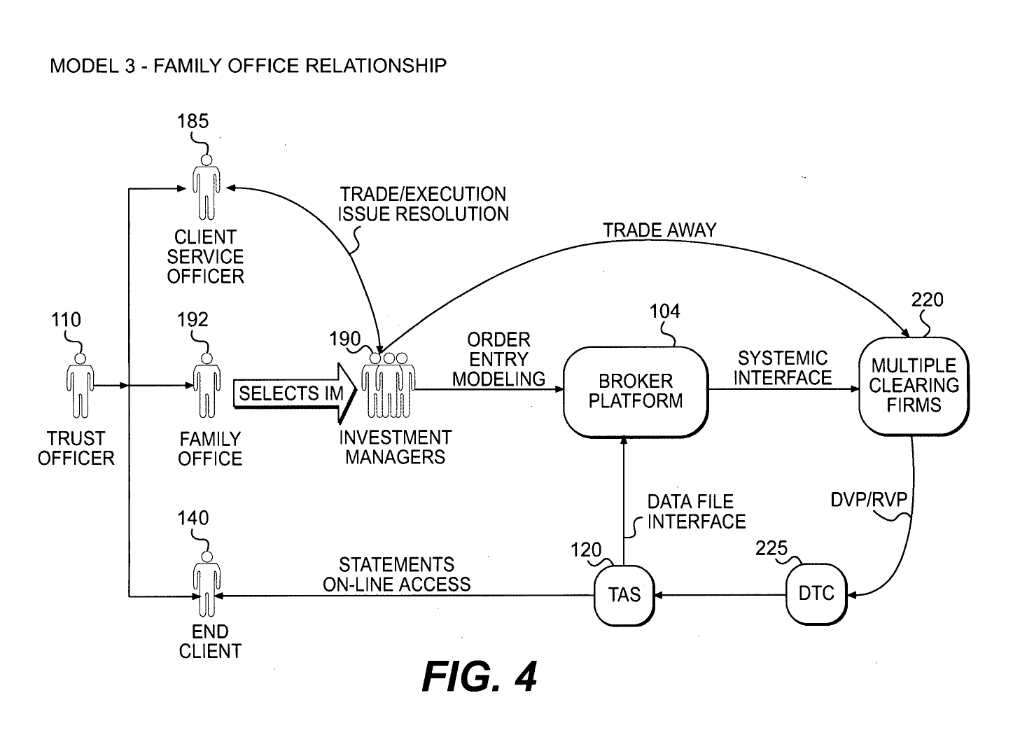

Model 3, shown in FIG. 4, depicts a model in which a family office 192 replaces consultant 180, as shown in Model 1. A Family Office is an end-to-end solution for high-net-worth individuals, providing all aspects of planning, investment management and tax reporting. (Family Offices may assume a fiduciary role.) An Investment Consultant is a firm or individual hired to provide expertise in one area of wealth management, i.e., asset allocation, accounting, performance monitoring, etc.

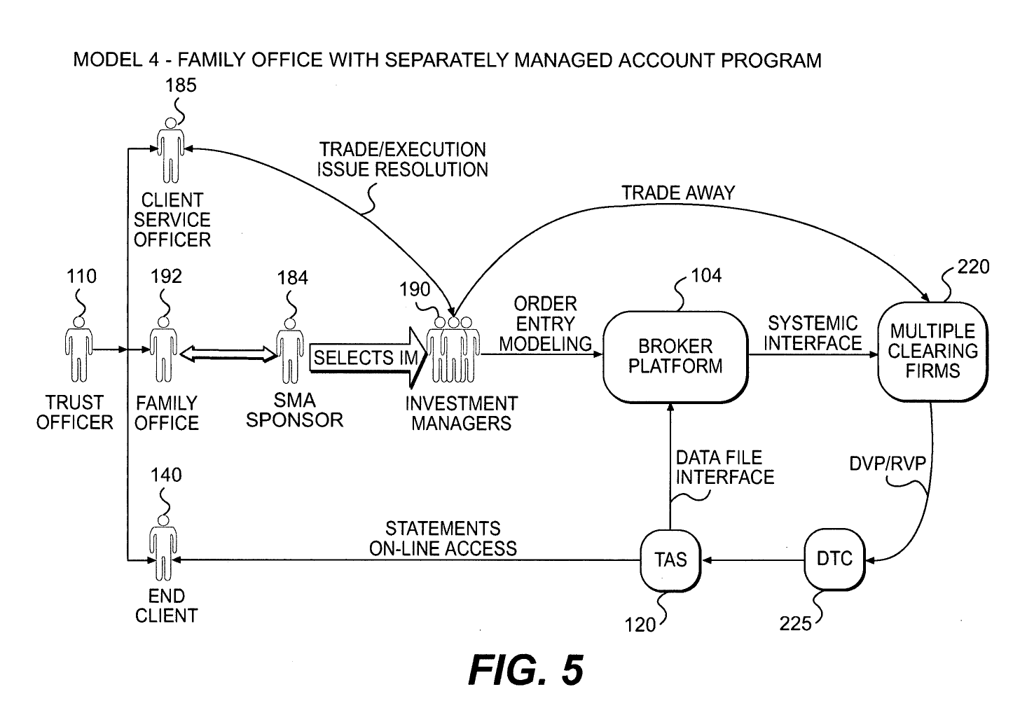

Model 4, shown in FIG. 5, is a family office counterpart to Model 2 in that a separately managed account sponsor 184 is interposed between family office 192 and investment managers 190 such that separately managed account sponsor 184 is the party that actually selects investment managers 190.

Model 5, which is shown in FIG. 6, depicts a model in which there is relatively more collaboration between a bank trustee and a particular broker platform. This model (and Model 6) enables joint promotion of the novel directed trust services, as well better issue resolution, among other benefits. In this case, trust officer 110 may coordinate with a client service officer 185 and an RIA 130. The RIA, as explained previously, may effect desired trades through online trading system 107 in connection with overall broker platform 104. When there are trade or execution issues to be resolved, RIA 130 may have an opportunity to communicate directly with operations personnel 608 of broker platform 104 and, as necessary, consult and reconcile outstanding issues with personnel from directed trust operations 605 of bank 102. As will be appreciated by those skilled in the art, when there is close integration between a bank trustee and an RIA, problems that might arise can be more easily resolved such that the end client or grantor or beneficiary 140 is benefited.

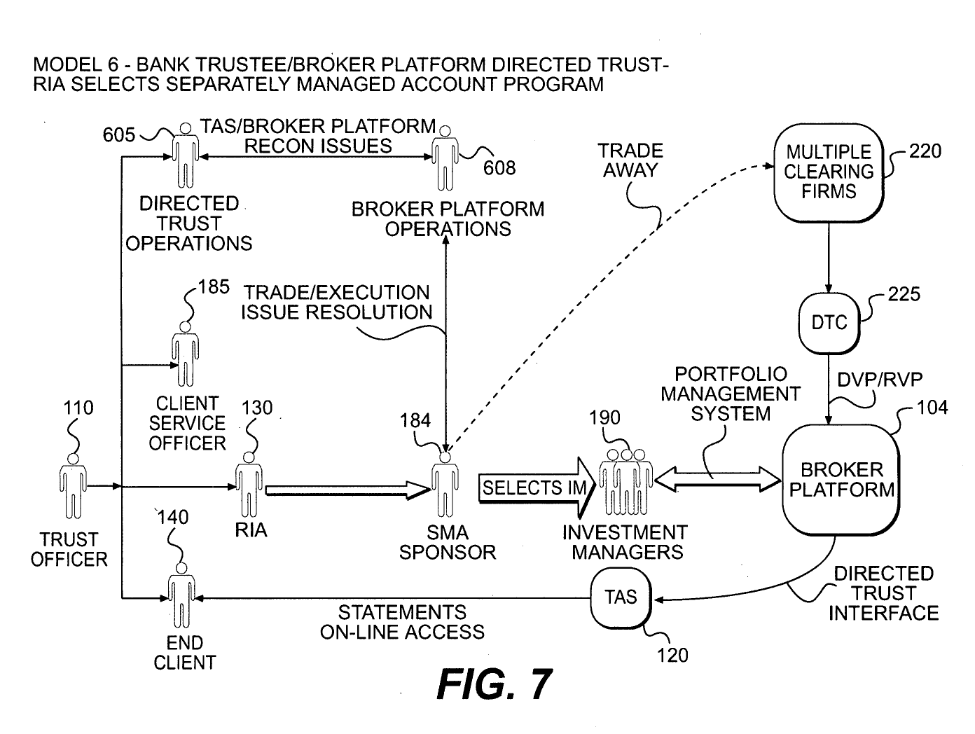

Model 6, illustrated in FIG. 7, depicts a model in which a separately managed account sponsor 184 is interposed between RIA 130 and investment managers 190. Separately managed account sponsor 184 may be the party responsible for selecting the investment managers and for coordinating with broker platform operations personnel 608.

Those skilled in the art will appreciate the several different ways in which the services of the present invention can be leveraged for the benefit of a given client. The systems and services described herein can be used in connection with broker dealers who are closely integrated with a bank trustee and with those that are less integrated. More specific, but non-limiting, information regarding relationships between the several interested parties depicted in FIGS. 2-7 and additional details regarding each of the models described above are set forth in the tables below. The following definitions are relevant to several of the terms in the tables:
Advent—software that provides portfolio accounting and comprehensive performance measurement. The software also provides flexible, robust reporting capabilities.
Inform and Inform Performance Analytics—INFORM provides information on custody, accounting, settlement and related activity. INFORM enables a web-enabled instruction capture capability for cash and securities, as well as foreign exchange instructions.
INFORMPerformance (Inform PA)—provides the ability to:
   Calculate rates of return and analytics at varying levels
   Access a wide range of universe comparisons and benchmark portfolio indices
   View performance and investment risk attribution and analysis
   Manage portfolio exposure
   Customize reports
Security APL—Also known as Checkfree APL and Checkfree Investment Services (CIS). Checkfree APL is a vendor solution that provides portfolio accounting and comprehensive performance measurement. Additionally, Checkfree APL provides an array of front-office and back-office tools to streamline process and create efficiency.
Swift Raw Data File—Account data file, containing all, or substantially all, data elements available on an account in a standard swift format.

PTIQ—An internal acronym to describe a user interface into the billing system.

TABLE 1
MODELS 1-4

| | | | |
|---|---|---|---|
| Model 1 | Model 2 | Model 3 | Model 4 |

Relationship

| | | | | | |
|---|---|---|---|---|---|
| 1. | Who is Bank's Client? | Consultant | Consultant | Family Office | Family Office |
| | | End Client | End Client | End Client | End Client |
| 2. | Who is Bank's Relationship | Consultant | Consultant | Family Office | Family Office |
| | with? | | | | |
| 3. | Who is the Trustee? | Bank | Bank | Bank | Bank |
| | | Co-trustee (where | Co-trustee (where | Co-trustee (where | Co-trustee (where |
| | | applicable) | applicable) | applicable) | applicable) |
| 4. | Who has custody of the | Bank | Bank | Bank | Bank |
| | assets? | | | | |
| 5. | Where is the cash held? | Bank | Bank | Bank | Bank |
| 6. | Who has delegation of | Consultant | Consultant | Family Office | Family Office |
| | authority? | Investment Manager | Investment Manager | Investment Manager | Investment Manager |

Trust Reporting

| | | | | | |
|---|---|---|---|---|---|
| 1. | What statement do the | From TAS | From TAS | From TAS | From TAS |
| | Grantor/Beneficiary | | | | |
| | receive? | | | | |
| 2. | Who produces/files tax | Bank | Bank | Bank | Bank |
| | reports? | | | | |
| 3. | Who provides performance | Investment Manager | Investment Manager | 3^{rd} Party Portfolio | 3^{rd} Party Portfolio |
| | reporting? | 3^{rd} Party System | 3^{rd} Party System | management | management |
| | | Inform PA (Where | Inform PA (Where | Inform PA (Where | Inform PA (Where |
| | | Applicable) | Applicable) | Applicable) | Applicable) |
| 4. | What feeds are available | Advent | Advent | Advent | Advent |
| | from Bank to 3^{rd} party | Security APL | Security APL | Security APL | Security APL |
| | systems? | Swift Raw Data Files | Swift Raw Data Files | Swift Raw Data Files | Swift Raw Data Files |
| | | Bank standard files | Bank standard files | Bank standard files | Bank standard files |

Investment Management

| | | | | | |
|---|---|---|---|---|---|
| 1. | Who initiates trade orders? | Investment Manager | Investment Manager | Investment Manager | Investment Manager |
| 2. | How are portfolios modeled? | 3^{rd} Party Portfolio | 3^{rd} Party Portfolio | 3^{rd} Party Portfolio | 3^{rd} Party Portfolio |
| | | Management System | Management System | Management System | Management System |
| 3. | Where are orders entered? | 3^{rd} Party Portfolio | 3^{rd} Party Portfolio | 3^{rd} Party Portfolio | 3^{rd} Party Portfolio |
| | | Management System | Management System | Management System | Management System |
| | | Directly with Clearing | Directly with Clearing | Directly with Clearing | Directly with Clearing |
| | | Firm | Firm | Firm | Firm |
| 4. | How are trades executed? | Clearing Firms (i.e. | Clearing Firms (i.e. | Clearing Firms (i.e. | Clearing Firms (i.e. |
| | | Pershing, Bear Stearns, | Pershing, Bear Stearns, | Pershing, Bear Stearns, | Pershing, Bear Stearns, |
| | | etc) | etc) | etc) | etc) |
| 5. | How do trades get affirmed? | Investment Manager | Investment Manager | Investment Manager | Investment Manager |
| | | Bank through an Auto | SMA sponsor | Bank through an Auto | SMA sponsor |
| | | Affirm process or | Bank through an Auto | Affirm process or | Bank through an Auto |
| | | manually with fax | Affirm process or | manually with fax | Affirm process or |
| | | | manually with fax | | manually with fax |

Account Administration

| | | | | | |
|---|---|---|---|---|---|
| 1. | Contact for Trust Officer | Consultant | Consultant | Family Office | Family Office |
| | to resolve non-trading | | | | |
| | issues? | | | | |
| 2. | Contact for Client Service | Investment Manager | Investment Manager | Investment Manager | Investment Manager |
| | Officer to resolve trade/ | | | | |
| | execution issues? | | | | |
| 3. | How is the Trust | Fees established | Fees established | Fees established | Fees established |
| | Administration fee | within PTIQ | within PTIQ | within PTIQ | within PTIQ |
| | calculated and collected? | Fee system within | Fee system within | Fee system within | Fee system within |
| | | Bank calculates and | Bank calculates and | Bank calculates and | Bank calculates and |
| | | initiates debit to | initiates debit to | initiates debit to | initiates debit to |
| | | Trust Account | Trust Account | Trust Account | Trust Account |
| 4. | How are others' fees | Client Service Officer | Client Service Officer | Client Service Officer | Client Service Officer |
| | calculated and collected? | receives a bill from | receives a bill from | receives a bill from | receives a bill from |
| | | the Investment Manager | Plan sponsor | Plan sponsor | Plan sponsor |
| | | Client Service Officer | Client Service Officer | Client Service Officer | Client Service Officer |
| | | initiates a debit to | initiates a debit to | initiates a debit to | initiates a debit to |
| | | the trust account via | the trust account via | the trust account via | the trust account via |
| | | TAS | TAS | TAS | TAS |

TABLE 2
MODELS 5 and 6

| | |
|---|---|
| Model 5 | Model 6 |

Relationship

| | | | |
|---|---|---|---|
| 1. | Who is Bank's Client? | Registered Investment | Registered Investment |
| | | Advisor | Advisor |
| | | End client | End client |
| 2. | Who is Bank's | Registered Investment | Registered Investment |
| | Relationship with? | Advisor | Advisor |
| 3. | Who is the Trustee? | Bank | Bank |
| | | Co-trustee | Co-trustee |
| | | (where applicable) | (where applicable) |
| 4. | Who has custody of the | Partner Securities | Partner Securities |
| | assets? | broker/dealer: Principal | broker/dealer: Principal |
| | | securities | securities |
| | | Bank: Income and | Bank: Income and |
| | | Principal cash | Principal cash |
| 5. | Where is the cash held? | Bank | Bank |
| 6. | Who has delegation of | Registered Investment | Registered Investment |
| | authority? | Advisor | Advisor |

Trust Reporting

| | | | |
|---|---|---|---|
| 1. | What statement do the | From TAS | From TAS |
| | Grantor/Beneficiary | | |
| | receive? | | |
| 2. | Who produces/files tax | Bank | Bank |
| | reports? | | |
| 3. | Who provides performance | Advent | Advent |
| | reporting? | | |
| 4. | What feeds are available | Advent | Advent |
| | from Bank to 3^{rd} party | Security APL | Security APL |
| | systems? | Swift Raw Data Files | Swift Raw Data Files |
| | | Bank standard files | Bank standard files |

Investment Management

| | | | |
|---|---|---|---|
| 1. | Who initiates trade | Registered Investment | Registered Investment |
| | orders? | Advisor | Advisor |
| 2. | Where are orders | Partner broker platform | Partner broker platform |
| | entered? | Directly with 3^{rd} | Directly with 3^{rd} |
| | | Party clearing firm | Party clearing firm |
| 3. | How are trades executed? | Through Partner broker | Through Partner broker |
| | | platform | platform |
| | | Directly with 3^{rd} Party | Through 3^{rd} Party |
| | | clearing firm | clearing firm |
| 4. | How do trades get affirmed? | No affirmation required for | No affirmation required |
| | | partner broker | for partner broker |
| | | Trade-aways are affirmed | Trade-aways are affirmed |
| | | through Partner broker | through Partner broker |
| | | using fax trade | using fax trade |
| | | confirmations | confirmations |

Account Administration

| | | | |
|---|---|---|---|
| 1. | Contact for Trust Officer | Registered Investment | Registered Investment |
| | to resolve non-trading | Advisor | Advisor |
| | issues? | | SMA Sponsor |
| 2. | Contact for Client Service | Client Service Officer | Client Service Officer |
| | Officer to resolve trade/ | is not directly involved in | is not directly involved in |
| | execution issues? | this relationship | this relationship |
| 3. | Who reconciles principal | Client Service Officer | Client Service Officer |
| | funding of trust Assets to | | |
| | Partner broker | | |
| 4. | Contact for Client Service | Registered Investment | Registered Investment |
| | Officer to resolve funding | Advisor | Advisor |
| | breaks? | | |
| 5. | Who reconciles TAS to | Directed Trust Operations | Directed Trust Operations |
| | Partner broker | | |
| 6. | How is cash transferred | Directed Trust Operations | Directed Trust Operations |
| | between Partner broker and | net settles at least daily | net settles at least daily |
| | Bank to cover transactions | between Bank and partner | between Bank and partner |
| | | broker | broker |
| 7. | How are fees calculated | All fess established | All fess established |
| | and collected? | within Partner broker's | within Partner broker's |
| | | billing system | billing system |

From a business perspective, it is desirable to promote the trust services that are available through bank 102 and, in particular, those services that facilitate directed trusts. In this connection, dedicated personnel may be fielded to support the sales, service and operations of the directed trust services offered by bank 102. More specifically, a directed trust wholesaler can be appointed to attend regional client product conferences, introduce services directly to IBD/RIA Senior Management, introduce Trust Officers to Investment Professionals of IBD/RIA firms, and conduct ongoing product training for brokers and managers.

Another position may be reserved for a Delaware trust officer who may be located in, for example, Delaware, who is fluent in Delaware direction trust law and who maintains integrity of jurisdiction selection for tax and regulatory purposes. This trust officer may also introduce/explain services directly to IBD/RIA investment professionals, assist in end-client (trust grantors) sales with investment professionals, conduct initial review and acceptance of new/successor trusts, attend regional client product conferences (as needed), and conduct ongoing product training for brokers and managers (as needed). Personnel in this position may also perform TIC/TAR reviews.

Still another position may be a directed trust relationship manager. This position maybe located in the geographic region, e.g., city, in which bank 102 is headquartered and is responsible for maintaining client relationships with IBD/RIA clients, interfacing with Relationship Managers for the establishment of IBD/RIA Sub-Advisor Relationships, and introducing Trust Officers to RIAs for the sale and establishment of new directed trust accounts.

Dedicated trust officers may also be located in the headquarter city of bank 102 to provide services under any pre-existing service agreements. These personnel may be fluent in trust law and have expert knowledge of directed trusts. They may be able to maintain the integrity of jurisdiction selection for tax and regulatory purposes, introduce the services directly to IBD/RIA investment professionals, and assist in end-client (trust grantors) sales with investment professionals. They may also conduct initial review and acceptance of new/successor trusts, attend regional client conferences (as needed), conduct ongoing product training for relationship and account managers (as needed), and perform TIC/TAR reviews.

The directed trust services of the invention may also be marketed via brochures, fact sheets, and sales pitch-books that can be provided to interested parties including RIA/IBD firms, and RIA/IAR representatives. These materials may also be available through online trading system 107.

It is recognized that, when not in the context of a Delaware Direction Trust, or a trust with similar characteristics, there is always a reputational risk to bank 102 as a premier trustee, in that an opportunity exists for beneficiaries of the trust to initiate a lawsuit based on alleged poor performance of an investment manager. To counter this risk, several systemic and operational controls are preferably implemented. First, bank 102 may work closely with RIA 130 to establish an Investment Policy for the trust. Second, a daily (at least) interface between TAS 120 and a reporting module 150 may provide sufficient information for the TIC and TAR. Finally, as fiduciary, bank 102 may have the ability to remove an RIA from the investment management role of the trust based on poor performance. Of course, bank 102 can work closely with an IBD (when applicable), any co-trustees and potentially the grantor and/or income beneficiaries to resolve any issues prior to replacing a given RIA.

Bank 102 may also consider the issue of third-party investment management credit worthiness. Specifically, by delegating investment management to third party firms, bank 102 assumes a certain risk as to a money manager's firm's stability. To address and mitigate any potential issues arising from poor stability, a broker/dealer partner of bank 102 may perform a review of each IBD during initial relationship establishment to utilize the directed trust services of the invention. Bank 102 may capture and maintain copies of any such review, so that bank 102 can make its own assessment of the situation.

As trustee, bank 102 must maintain control of all assets of the trust. However, with a broker/dealer partner acting as custodian for the principal securities, there is the potential risk that a Third-Party Manager could distribute assets without the knowledge of bank 102. This risk may be mitigated through systemic controls implemented to restrict any assets from leaving the account management system 104 without approval of a trust officer 1 10 of bank 102. Specifically, in at least one implementation, all ACATS, checks, wires and ACH transactions may be blocked within accounts of account management system 104. Additionally, registration of the accounts in account management system 104 in the name of bank 102 as trustee may prohibit remittance of assets from a given account without approval of bank 102.

Finally, as with any investment account, there is a risk the account might be established for money laundering purposes. This is a particular concern since a representative of bank 102 may not meet the end client in most cases. To mitigate this risk, a comprehensive account opening checklist may be required. At the same time, individual IBD/RIA firms may implement their own requirements/documents to comply with relevant regulations and laws, and such documents may be captured in addition to the account opening checklist mentioned above. In at least one implementation, the checklists and documents may require multiple signatures.

As will be appreciated by those skilled in the art, the foregoing system and methods and services may create a new channel for trust revenue through a competitive, advisor-friendly, wholesale-directed trust product through IBD and RIA relationships. Without the features described above, third-party money management for trusts is difficult, if not completely impractical.

The foregoing disclosure of embodiments of the invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for implementing directed trust services, comprising:
establishing a data interface between a trust accounting system operated by a trustee and a securities broker platform;
opening an account on the securities broker platform in the name of the trustee for the benefit of a client;
providing access to the account to a registered investment advisor who is designated to provide investment services on behalf of the client;
updating the securities broker platform, using the data interface, with information sufficient to notify the registered investment advisor of an amount of trust assets that are available to the registered investment advisor for investment;
receiving information, using the data interface, indicative of any investments made by the registered investment advisor on behalf of the client and any income resulting from any such investments; and
updating the trust accounting system based on the information indicative of any investment made and any income resulting from any such investments,
wherein the steps of (i) updating the securities broker platform, using the data interface, with information sufficient to notify the registered investment advisor of an amount of trust assets that are available to the registered investment advisor for investment and (ii) receiving information, using the data interface, indicative of any investments made by the registered investment advisor on behalf of the client and any income resulting from any such investments are performed daily.

2. The method of claim 1, further comprising providing a portal via which the client can view a state of assets of the trust.

3. The method of claim 1, wherein the trust accounting system is operated by a bank.

4. The method of claim 3, further comprising monitoring investments made by the registered investment advisor from within the bank.

5. The method of claim 1, further comprising generating reports from the trust accounting system.

6. The method of claim 5, wherein the reports comprise at least one of statements, confirms, tax reports, scheduled remittances, and discretionary payments.

7. The method of claim 1, further comprising restricting ways in which cash can leave the account on the securities broker platform.

8. The method of claim 7, further comprising blocking at least one of ACATS, checks, wire transfers and ACH transactions from the account on the securities broker platform.

9. The method of claim 1, wherein the operator of the trust accounting system holds both principal and income portions of the trust assets.

10. The method of claim 1, wherein an amount of the principal is used for updating the securities broker platform.

11. The method of claim 1, wherein the directed trust services are employed for a Delaware Direction Trust.

12. The method of claim 1, wherein the steps of updating the securities broker platform and receiving information are performed a plurality of times per day.

13. A method for providing directed trust services, comprising:
establishing an electronic data interface between a trust accounting system and a securities broker platform;
setting up a securities trading account on the securities broker platform in connection with a trust account on the trust accounting system;
sending, over the electronic data interface, to the trading account on the securities broker platform an amount of principal cash of a trust designated for investment by an investment advisor, the principal cash and any related income of the trust being accounted for by the trust accounting system;
receiving, over the electronic data interface, information regarding any return on any investments made via the securities broker platform; and
updating the trust accounting system accordingly,
wherein the sending and receiving are preformed daily.

14. The method of claim 13, wherein the trust accounting system is operated by a bank.

15. The method of claim 14, wherein the securities trading account is set up in the name of the bank for the benefit of a beneficiary of a trust.

16. The method of claim 13, wherein an operator of the trust accounting system holds principal and income of the trust.

17. The method of claim 13, wherein the directed trust services are provided for a Delaware Direction Trust.

18. The method of claim 13, wherein the investment advisor is a Registered Investment Advisor.

19. The method of claim 13, further comprising generating reports from the trust accounting system.

20. The method of claim 19, wherein the reports comprise at least one of statements, confirms, tax reports, scheduled remittances, and discretionary payments.

21. The method of claim 13, further comprising restricting ways in which cash can leave the securities trading account on the securities broker platform.

22. The method of claim 21, further comprising blocking at least one of ACATS, checks, wire transfers and ACH transactions from the account on the securities broker platform.

23. A system for providing directed trust services, comprising:
a trust accounting system operated by a trustee, the trust accounting system storing accounting data related to principal and income portions of a plurality of trusts; and
a broker platform operable to receive and effect securities trades; and
an electronic data interface connecting the trust accounting system and the broker platform, the trust accounting system indicating to the broker platform, via the electronic interface, an amount of principal funds that are available for securities trades, and the broker platform reporting to the trust accounting system, via the electronic data interface, information relating to any securities trades,
wherein the principal funds used for securities trades are held by the trustee.

24. The system of claim 23, wherein the electronic data interface passes the amount of principal funds that are available for securities trades and the information relating to any securities trades at least as often as daily.

25. The system of claim 23, wherein the electronic data interface is based on an electronic data interchange protocol.

26. The system of claim 23, wherein a registered investment advisor effects the securities trades.

27. The system of claim 23, further comprising an online portal via which a creator of a trust or a beneficiary of the trust can obtain information about the trust that is available from the trust accounting system.

28. The system of claim 23, further comprising a reporting module in communication with the trust accounting system.

29. The system of claim 23, wherein the trustee is a financial institution.

30. The system of claim 23, wherein the trustee is a bank.

31. The system of claim 23, wherein the trust accounting system is operable to generate at least one of statements, confirms, tax reports, scheduled remittances, and discretionary payments.

32. The system of claim 23, wherein the broker platform is blocked from disseminating cash by at least one of ACATS, checks, wire transfers and ACH transactions.
